(19) United States
(12) Patent Application Publication
(10) Pub. No.: US 2020/0172723 A1
(43) Pub. Date: Jun. 4, 2020

(54) FAST-CURING EPOXY SYSTEMS

(71) Applicant: Evonik Operations GmbH, Essen (DE)

(72) Inventors: Emmanouil Spyrou, Schermbeck (DE); Dirk Fuchsmann, Haltern am See (DE); Britta Kohlstruk, Gladbeck (DE); Annette Sandkühler, Marl (DE)

(73) Assignee: Evonik Operations GmbH, Essen (DE)

(21) Appl. No.: 16/684,969

(22) Filed: Nov. 15, 2019

(30) Foreign Application Priority Data
Nov. 29, 2018 (EP) 18209073.8

(51) Int. Cl. C08L 63/00; C09J 163/00; C09D 163/00

(52) U.S. Cl. CPC C08L 63/00; C08K 5/17; C09D 163/00; C09J 163/00

(57) ABSTRACT

The present invention relates to compositions comprising at least one epoxy resin, at least one amine having at least two secondary amino groups that are both part of an organic ring system, and at least one alkyl alcohol optionally substituted by at least one aromatic radical and/or by at least one alkenyl radical, to processes for production thereof and to the use thereof.

This application is a 35 U.S.C. § 119 patent application which claims the benefit of European Application No. 18209073.8 filed Nov. 29, 2018, which is incorporated herein by reference in its entirety.

### FIELD

Epoxy resins, especially those that are prepared from bisphenol A and epichlorohydrin, are known raw materials for the production of high-quality casting resins, coating compositions, composites and adhesives. Aromatic epoxy resins cured with polyamines have not only good chemical and solvent resistance but also good bond strength on many substrates.

### BACKGROUND

The curing of epoxy-amine coating systems can be accelerated using catalysts (U.S. Pat. Nos. 3,492,269 A, 5,470,896 A, GB 1,105,772 A).

EP 0 083 813 A1, EP 2 957 584 A1, U.S. Pat. Nos. 5,441,000 A, 5,629,380 A, WO 96/09352 A1 disclose the catalysed curing of epoxy resins with various amines.

CN 106905816 A, CN 106833261 A, JP H08-113876 A, DE 1 954 701 A1, CA 2 165 585 A1 and U.S. Pat. No. 3,055,901 A disclose the catalyst-free curing of epoxy resins with aminoethylpiperazine.

EP 0 969 030 A1 discloses epoxy/amine coating systems wherein the amine component is an aliphatic amine. The compositions may include a catalyst. In the examples, aminoethylpiperazine is also used as hardener.

U.S. Pat. No. 4,775,734 A discloses the curing of epoxy resins with, inter alia, aminoethylpiperazine, bis(aminopropyl)piperazine or piperidine using catalytic amounts of tetrafluoroborate or hexafluorophosphate salts of various amines.

EP 3 255 078 A1 discloses epoxy resin compositions comprising at least one epoxy compound, 2-(2,2,6,6-tetramethylpiperidin-4-yl)propane-1,3-diamine, and optionally a catalyst which may be an inorganic salt inter alia.

It has been found that amines having at least two secondary amino groups that are both part of an organic ring system are capable of particularly rapidly curing epoxy resin compositions.

U.S. Pat. Nos. 8,951,619 B2 and 9,006,385 B2 disclose, inter alia, the catalyst-free curing of epoxy resins with unsubstituted piperazines inter alia.

WO 2017/074810 A1 discloses compositions comprising an epoxy resin, a polyetheramide and a further amine hardener which may be an imidazole or imidazoline inter alia. Also used is a metal triflate catalyst.

EP 18172950.0, unpublished to date, discloses a low-alkylphenol composition comprising at least one epoxy resin, at least one amine having at least two secondary amino groups that are both part of an organic ring system, and at least one salt of a strong Brønsted acid. EP 18172954.2, unpublished to date, discloses a low-alkylphenol composition comprising at least one epoxy resin, at least one amine having at least two secondary amino groups that are part of an organic ring system, and at least one salt of a very strong Brønsted acid.

US 2012/0010330 A1 discloses the curing of an epoxy resin with, inter alia, a cyclic diamine selected from piperazine and homopiperazine in the presence of at least 10% of an alkylphenol in order to increase the reactivity of the composition and to lower the glass transition point Tg (alkylphenol acts as a plasticizer). However, disadvantages of the use of phenol-containing additives are their allergenicity and toxicity.

A further common factor in the prior art compositions is that they cure too slowly or only at high temperatures and are not reactive enough.

For many applications, however, it is important that surface curing or complete through-curing proceeds particularly rapidly or else at low temperatures. Firstly, productivity can be increased or else the next processing step can be accelerated. The latter is important particularly in cold regions in order, for example, to provide ships or pipelines with a corrosion protection coating, such that continued operation is possible there in winter as well.

### SUMMARY

The problem addressed in the present context is thus that of providing epoxy systems that react much more quickly under the same conditions than the formulations known to date and have a low glass transition temperature Tg. Another problem addressed was that of providing epoxy formulations that partly or fully cure more quickly than is possible to date at temperatures well below room temperature. It would also be desirable if they were very substantially free of toxic and allergenic additives.

### DETAILED DESCRIPTION

These present problems are solved by the compositions according to the invention comprising

a) at least one epoxy resin,

b) at least one cyclic amine having at least two secondary amino groups that are both part of an organic ring system, and

c) at least one alkyl alcohol optionally substituted by at least one aromatic radical and/or by at least one alkenyl radical.

The composition preferably contains less than 5% by weight, further preferably less than 3% by weight, based on the total mass of the composition, of substituted or unsubstituted phenols. Further preferably, the compositions of the invention continue to be phenol-free, meaning that they do not contain any phenols or substituted phenols. Substituted phenols are understood here to mean compounds structurally derived from phenol. More particularly, the compositions according to the invention preferably do not contain any alkylated phenols. Corresponding low-phenol or phenol-free compositions have the advantage of low toxicity and allergenicity levels.

Component a) is at least one epoxy resin. All epoxy compounds are suitable in principle for this purpose.

Suitable epoxy compounds are described, for example, in EP 675 185 A2. Useful compounds are a multitude of the known compounds containing more than one epoxy group, preferably two epoxy groups, per molecule. These epoxy compounds may be either saturated or unsaturated and aliphatic, cycloaliphatic, aromatic or heterocyclic and may also have hydroxyl groups. They may additionally contain such substituents that do not cause any troublesome side reactions under the mixing or reaction conditions, for example alkyl or aryl substituents or ether moieties.

Preferred epoxy compounds here are glycidyl ethers which derive from polyhydric phenols, especially bisphenols and novolaks, and which have molar masses based on the number of epoxy groups ME (“epoxy equivalent weights”, “EV value”) between 100 and 1500 g/eq, but especially between 150 and 250 g/eq.

Particularly preferred epoxy compounds derive from resorcinol, hydroquinone, 2,2-bis(4-hydroxyphenyl)propane (bisphenol A), isomer mixtures of dihydroxydiphenylmethane (bisphenol F), 4,4′-dihydroxydiphenylcyclohexane, 4,4′-dihydroxy-3,3′-dimethyldiphenylpropane, 4,4′-dihydroxydiphenyl, 4,4′-dihydroxybenzophenone, bis(4-hydroxyphenyl)-1,1-ethane, bis(4-hydroxyphenyl)-1,1-isobutane, 2,2-bis(4-hydroxy-tert-butylphenyl)propane, bis(2-hydroxynaphthyl)methane, 1,5-dihydroxynaphthalene, tris(4-hydroxyphenyl)methane, bis(4-hydroxyphenyl) ether, bis(4-hydroxyphenyl) sulfone, and the chlorination and bromination products of the aforementioned compounds (for example tetrabromobisphenol A).

Very particular preference is given to using liquid diglycidyl ethers based on bisphenol A and bisphenol F having an epoxy equivalent weight of 150 to 200 g/eq.

It is also possible with preference to use polyglycidyl ethers of polyalcohols, for example ethane-1,2-diol diglycidyl ether, propane-1,2-diol diglycidyl ether, propane-1,3-diol diglycidyl ether, butanediol diglycidyl ether, pentanediol diglycidyl ether (including neopentyl glycol diglycidyl ether), hexanediol diglycidyl ether, diethylene glycol diglycidyl ether, dipropylene glycol diglycidyl ether, higher polyoxyalkylene glycol diglycidyl ethers, for example higher polyoxyethylene glycol diglycidyl ethers and polyoxypropylene glycol diglycidyl ethers, co-polyoxyethylene-propylene glycol diglycidyl ethers, polyoxytetramethylene glycol diglycidyl ethers, polyglycidyl ethers of glycerol, of hexane-1,2,6-triol, of trimethylolpropane, of trimethylolethane, of pentaerythritol or of sorbitol, polyglycidyl ethers of oxyalkylated polyols (for example of glycerol, trimethylolpropane, pentaerythritol, inter alia), diglycidyl ethers of cyclohexanedimethanol, of bis(4-hydroxycyclohexyl)methane and of 2,2-bis(4-hydroxycyclohexyl)propane, polyglycidyl ethers of castor oil, triglycidyl tris(2-hydroxyethyl)isocyanurate.

Further useful components A) include: poly(N-glycidyl) compounds obtainable by dehydrohalogenation of the reaction products of epichlorohydrin and amines such as aniline, n-butylamine, bis(4-aminophenyl)methane, m-xylylenediamine or bis(4-methylaminophenyl)methane. However, the poly(N-glycidyl) compounds also include triglycidyl isocyanurate, triglycidylurazole and oligomers thereof, N,N′-diglycidyl derivatives of cycloalkyleneureas and diglycidyl derivatives of hydantoins.

In addition, it is also possible with preference to use polyglycidyl esters of polycarboxylic acids which are obtained by the reaction of epichlorohydrin or similar epoxy compounds with an aliphatic, cycloaliphatic or aromatic polycarboxylic acid such as oxalic acid, succinic acid, adipic acid, glutaric acid, phthalic acid, terephthalic acid, tetrahydrophthalic acid, hexahydrophthalic acid, naphthalene-2,6-dicarboxylic acid and higher diglycidyl dicarboxylates, for example dimerized or trimerized linolenic acid. Examples are diglycidyl adipate, diglycidyl phthalate and diglycidyl hexahydrophthalate.

Also preferred are glycidyl esters of unsaturated carboxylic acids and epoxidized esters of unsaturated alcohols or unsaturated carboxylic acids. In addition to the polyglycidyl ethers, it is possible to use small amounts of monoepoxides, for example methyl glycidyl ether, butyl glycidyl ether, allyl glycidyl ether, ethylhexyl glycidyl ether, long-chain aliphatic glycidyl ethers, for example cetyl glycidyl ether and stearyl glycidyl ether, monoglycidyl ethers of a higher isomeric alcohol mixture, glycidyl ethers of a mixture of C12 to C13 alcohols, phenyl glycidyl ether, cresyl glycidyl ether, p-tert-butylphenyl glycidyl ether, p-octylphenyl glycidyl ether, p-phenylphenyl glycidyl ether, glycidyl ethers of an alkoxylated lauryl alcohol, and also monoepoxides such as epoxidized monounsaturated hydrocarbons (butylene oxide, cyclohexene oxide, styrene oxide), in proportions by mass of up to 30% by weight, preferably 10% to 20% by weight, based on the mass of the polyglycidyl ethers.

A detailed enumeration of the suitable epoxy compounds can be found in the handbook “Epoxidverbindungen and Epoxidharze” [Epoxy Compounds and Epoxy Resins] by A. M. Paquin, Springer Verlag, Berlin 1958, Chapter IV, and in Lee Neville “Handbook of Epoxy Resins”, 1967, Chapter 2.

Useful epoxy compounds preferably include glycidyl ethers and glycidyl esters, aliphatic epoxides, diglycidyl ethers based on bisphenol A and/or bisphenol F, and glycidyl methacrylates. Other examples of such epoxides are triglycidyl isocyanurate (TGIC, trade name: ARALDIT 810, Huntsman), mixtures of diglycidyl terephthalate and triglycidyl trimellitate (trade name: ARALDIT PT 910 and 912, Huntsman), glycidyl esters of Versatic acid (trade name: CARDURA E10, Shell), 3,4-epoxycyclohexylmethyl 3′,4′-epoxycyclohexanecarboxylate (ECC), ethylhexyl glycidyl ether, butyl glycidyl ether, pentaerythrityl tetraglycidyl ether (trade name: POLYPDX R 16, UPPC AG), and other Polypox products having free epoxy groups.

It is also possible to use mixtures of the epoxy compounds mentioned.

Particularly preferred epoxy resins are polyepoxides based on bisphenol A diglycidyl ether, bisphenol F diglycidyl ether, 4,4′-methylenebis[N,N-bis(2,3-epoxypropyl)aniline], hexanediol diglycidyl ether, butanediol diglycidyl ether, trimethylolpropane triglycidyl ether, propane-1,2,3-triol triglycidyl ether, pentaerythritol tetraglycidyl ether and diglycidyl hexahydrophthalate.

Preference is given to using mixtures of the aforementioned epoxy compounds as component A).

Useful amines b) having at least two secondary amine groups that are both part of an organic ring system in principle include all compounds having at least two secondary cyclic amino groups. Furthermore, the amines b), as NH carrier, may also have further primary or acyclic secondary amino groups. Preferably, however, the amines used in the compositions according to the invention do not have any further primary or acyclic secondary amino groups, meaning that they have exclusively at least two secondary amino groups that are part of an organic ring system. In addition, however, the amines used in accordance with the invention may also have tertiary amino groups that are unreactive.

An “organic ring system” is understood to mean a heterocyclic system which may have one, two or at least three nitrogen-containing heterocycles (optionally fused to non-nitrogen-containing heterocycles or non-heterocycles). The organic ring system may also have heteroatoms other than nitrogen in the nitrogen-containing cycles, especially oxygen, sulfur and/or phosphorus. “A nitrogen-containing cycle” in the present context is understood to mean a simple nitrogen-containing cycle or a simple nitrogen-containing cycle that shares a ring bond with a non-nitrogen-containing heterocycle, a cycloalkane, a cycloalkene or an aromatic hydrocarbon (i.e. a nitrogen-containing cycle to which a non-nitrogen-containing heterocycle, a cycloalkane, a cycloalkene or an aromatic hydrocarbon is optionally fused).

The amines having at least two secondary amino groups may also be corresponding reaction products of compounds having secondary cyclic amino groups and optionally further primary or acyclic secondary amino groups with groups reactive toward NH groups, especially mono- and polyepoxides (adducts), polyisocyanates, polycarbodiimides, phenols (Mannich reactions with aldehydes and ketones), and substituted phenols (exchange of a Mannich base), polyesters, polycarboxylic acids, polyacrylates and polymethacrylates.

In a preferred embodiment, the amines b) are amines having at least two secondary cyclic amino groups, of which at least two belong to different cycles. More preferably, the amines b) are amines having two to four secondary cyclic amino groups on two to four different cycles. Corresponding amines having at least two different cycles are preferably also understood to mean fused heterocycles composed of at least two simple heterocycles.

Most preferably, the at least two secondary cyclic amino groups belong to the same cycle.

Even further preferred amines b) have the formula (I)

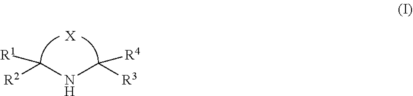

in which
R¹ to R⁴ is H or an organic radical, and

X=—(Y¹)ₘ-(A¹)ₙ-(Y²)ₒ-(A²)ₚ-(Y³)_{q}-(A³)ᵣ-(Y⁴)ₛ, (II)

where, independently of one another,
m, n, o, p, q, r and s=0 or 1,
A¹, A², A³=alkylene or alkenylene radical and
Y¹, Y², Y³, Y⁴=NR⁵, PR⁵, O or S, with R⁵ independently=H or organic radical,
where any two organic radicals selected from R¹ to R⁵ and any radicals present in the alkylene and/or alkenylene radicals A¹, A², A³ may also form one or more further rings,
with the proviso that at least one of the radicals selected from Y¹, Y², Y³, Y⁴ present is NR⁵ with R⁵=H.

The cyclic amines are saturated or partly unsaturated in relation to the ring shown in formula (I). Corresponding amines react more rapidly than the aromatic amines and imidazolines not covered by the formula. Further rings optionally present in the cyclic amine may be not only saturated or unsaturated, but also aromatic. Preferably, the further rings optionally present in the cyclic system are nonaromatic, i.e. saturated or unsaturated.

Preferred cyclic amines are saturated in relation to the ring shown in formula (I).

Preferably, at least one of the carbon atoms adjacent to the ring-bonded amino group=H, i.e. at least one of the R¹, R², R³ and R⁴ radicals=H. Further preferably, at least two of the R¹, R², R³ and R⁴ radicals=H. Preferably at least three and more preferably all of the R¹, R², R³ and R⁴ radicals=H. Correspondingly unsubstituted amines react more rapidly than other amines.

In the X radical, if present, A¹, A² and A³ are independently alkylene or alkenylene radicals. These may in turn bear organic radicals. If the alkylene and/or alkenylene radicals themselves have one or more organic radicals, any two organic radicals are selected from the organic radicals in the alkylene and/or alkenylene radicals may also form one or more further rings with one another or with any organic R¹ to R⁵ radicals present.

Radicals selected from R¹ to R⁵ present and any radicals present in the alkylene and/or alkenylene radicals A¹, A², A³ is substituted by at least one —NHR⁶ or —NH₂ group, where R⁶=organic radical. This means that, even in formula (I), as well as the at least two cyclic amino groups, there may also be further primary or acyclic secondary amino groups.

Preferably, A¹, A² and A³, if present, each independently have the formula (III))

—(CR⁷R⁸)ₓ—(CR⁹═CR¹⁰)_{y}—(CR¹¹R¹²)_{z}— (III)

in which, independently of one another,
R⁷, R⁸, R⁹, R¹⁰, R¹¹ and R¹²=H or organic radical and
1≤x+y+z≤7.

The indices x, y and z, in accordance with their pertinence to the A¹, A² and A³ radical, may preferably also be referred to as indices x¹, y¹ and z¹, as x², y² and z² and as x³, y³ and z³.

Preferably, X has a chain length of 2 to 15 atoms. Preferably, the sum total of all x, ½·y and z and of m, o, q and s has a value from 2 to 15, further preferably a value from 2 to 8, even further preferably a value from 2 to 5 and most preferably a value from 2 to 4. In other words, preferably, 2≤m+o+q+s+x¹+½·y¹+z¹+x²+½·y²+z²+x³+½·y³+z³≤15. Further preferably 2≤m+o+q+s+x¹+½·y¹+z¹+x²+½y²+z²+x³+½·y³+z³≤8, further preferably 2≤m+o+q+s+x¹+½·y¹+z¹+x²+½·y²+z²+x⁴+½·y³+z³≤5, most preferably 2≤m+o+q+s+x¹+½·y¹+z¹+x²+½·y²+z²+x³+½·y³+z³≤4.

The amines of the formula (I) are (optionally bi/poly)cyclic compounds since both carbon atoms adjacent to the amino group are attached on either side to the substituted (hetero)alkylene radical of the formula (II).

Further preferably, formula (I), as well as the nitrogen atom of the ring-attached NH group, has not more than one further heteroatom in the cycle, i.e. X preferably has the formula (IIa)

X=—(CR⁷R⁸)ₓ—(Y)ₒ—(CR¹¹R¹²)_{z}— (IIa)

with
x and z=0, 1, 2, 3, 4, 5, 6 or 7,
o=1,
2≤x+o+z≤15
R⁷, R⁸, R¹¹, R¹²=H or organic radical and
Y=NH.

Most preferably, in formula (IIa), z=z=1.

Correspondingly, in that case, any two organic radicals in formula (I) selected from R¹ to R⁸, R¹¹ and R¹² may also form one or more further rings.

The R¹, R², R³, R⁴, R⁵, R⁶, R⁷, R⁸, R⁹, R¹⁰, R¹¹ and R¹² radicals may be organic radicals. Preferred organic radicals are alkyl, alkenyl, alkynyl, aryl or aralkyl radicals. These may be heteroatom-substituted within their chain and/or bear substituents. Preferred organic radicals are alkyl, alkenyl, alkynyl, aryl or aralkyl radicals which may bear one or more ether, carboxyl, amino, amido, urea, carbamate, carbonate, amidino or guanidino groups within the chain. In addition, preferred organic radicals may have one or more substituents selected from hydroxyl radicals, nitrile radicals, halogen radicals and organic radicals, where the latter contain ether, carboxyl, amino, amido, urea, carbamate, carbonate, amidino or guanidino groups or may themselves be substituted by hydroxyl, nitrile or halogen radicals.

Particularly preferred amines b) are selected from the group consisting of 3,7-diazabicyclo[4.3.0]nonane, 2,8-diazabicyclo[4.3.0]nonane, 2-phenyl-2-imidazoline, 3,8-diazabicyclo[3.2.1]octane, 2,2′-bisimidazolidine, 1H-octahydroimidazo[4,5-c]pyridine, 1,4,8-triazaspiro[4.5]decane, 1,4-diazaspiro[4.5]decane, pyrazolidine, 2,2-dimethylimidazolidine, 1,4,7-triazacyclononane, decahydro-2,6-dimethylpyrazino[2,3-b]pyrazine, hexahydropyridazine, decahydro-4a,8a-dimethylpyrazino[2,3-b]pyrazine, 4,4′-methylenebis[piperidine], 2,2′-methylenebis[piperidine], tetradecahydro-4,7-phenanthroline, 2,2′-bipiperidine, 4,4′-bipiperidine, tetradecahydrophenazine, decahydroquinoxaline, 1,5-decahydronaphthyridine, octahydro-1H-cyclopentapyrazine, 2,2′-bipyrrolidine, piperazine, 2-methylpiperazine, 2,2-dimethylpiperazine, 2,3-dimethylpiperazine, 2-ethylpiperazine, 2,5-dimethylpiperazine, 2,6-dimethylpiperazine, 2,6-diazabicyclo[3.3.0]octane, 3,7-diazabicyclo[3.3.0]octane, 2,3,5,6-tetramethylpiperazine, 2,3,5-trimethylpiperazine, 2,2′-bipiperidine, 2-(2-piperidinyl)piperazine, 2,2′-bimorpholine, decahydro-2,6-naphthyridine, decahydro-2,7-naphthyridine, homopiperazine, 2-methylhomopiperazine, 6-methyl-1,4-diazepane, bis[2-(piperazin-1-yl)ethyl]amine, 1,2-dipiperazinoethane, 1,3-bis(4-piperidyl)propane and N-(4-piperidinylmethyl)-4-piperidinemethanamine.

Most preferably, the amine b) is homopiperazine.

Alkyl alcohols C) optionally substituted by at least one aromatic radical and/or by at least one alkenyl radical (referred to hereinafter as “alcohols”) are compounds having at least one alkyl-bonded OH group. Thus, the alcohols C) have an alkyl group bearing at least one OH group. The alkyl alcohol may consist exclusively of alkyl group and OH group(s). Alternatively, the alkyl alcohol may also have alkyl groups substituted by at least one aromatic radical and/or at least one alkenyl radical. Preference is given to alcohols having only one OH group, i.e. monoalcohols, especially those selected from the group consisting of methanol, ethanol, propanol, butanol, benzyl alcohol, substituted benzyl alcohols and reaction products of benzyl alcohol with ethylene oxide or propylene oxide. However, it may also be advantageous to use polyalcohols, especially those selected from the group consisting of ethylene glycol, propylene glycol, polyethylene glycols, polypropylene glycols, polyester polyalcohols, polyether polyalcohols, polycarbonate polyalcohols, polycaprolactone polyalcohols and polyacrylate polyalcohols.

Preferred alcohols are liquid at room temperature. Particularly preferred alcohols have a boiling point of at least 200° C. at 1013 mbar.

The alcohol is most preferably benzyl alcohol.

Component C is preferably present in such an amount that the contribution of this alcohol to the total concentration of OH groups is at least 1.3 mol/l, preferably at least 1.4 mol/l. Further preferably, the contribution of this alcohol to the total concentration of OH groups is at least 1.5 mol/l and very especially preferably at least 1.6 mol/l and even further preferably at least 1.8 mol/l. The corresponding concentration can be derived from the corresponding starting weight.

The proportion of the alcohol, especially of the benzyl alcohol, is preferably at least 20% by weight, more preferably at least 30% by weight and most preferably at least 40% by weight of the overall formulation.

Preferably, the compositions according to the invention may also include d) amines that do not have at least two secondary amine groups as part of an organic ring system, and/or e) further auxiliaries or additives.

Such amines d) are preferably di- or polyamines. These may be monomeric, oligomeric and/or polymeric compounds. Preferred monomeric and oligomeric compounds are selected from the group consisting of diamines, triamines and tetramines. The amine group of the di- or polyamines d) may be attached to a primary, secondary or tertiary carbon atom, preferably to a primary or secondary carbon atom. It is also possible to use mixtures of di- and/or polyamines as component d).

Components d) used may preferably be the following amines, alone or in mixtures:
aliphatic amines, especially the polyalkylenepolyamines, preferably selected from ethylene-1,2-diamine, propylene-1,2-diamine, propylene-1,3-diamine, butylene-1,2-diamine, butylene-1,3-diamine, butylene-1,4-diamine, 2-(ethylamino)ethylamine, 3-(methylamino)propylamine, diethylenetriamine, triethylenetetramine, pentaethylenehexamine, trimethylhexamethylenediamine, 2,2,4-trimethylhexamethylenediamine, 2,4,4-trimethylhexamethylenediamine, 2-methylpentanediamine, hexamethylenediamine, N-(2-aminoethyl)ethane-1,2-diamine, N-(3-aminopropyl)propane-1,3-diamine, N,N″-1,2-ethanediylbis(1,3-propanediamine), dipropylenetriamine, adipic dihydrazide and hydrazine;
oxyalkylenepolyamines, preferably selected from polyoxypropylenediamine and polyoxypropylenetriamine (e.g. Jeffamine® D-230, Jeffamine® D-400, Jeffamine® T-403, Jeffamine® T-5000), 1,13-diamino-4,7,10-trioxatridecane, 4,7-dioxadecane-1,10-diamine;
cycloaliphatic amines, preferably selected from isophoronediamine (3,5,5-trimethyl-3-aminomethylcyclohexylamine), 4,4′-diaminodicyclohexylmethane, 2,4′-diaminodicyclohexylmethane and 2,2′-diaminodicyclohexylmethane, alone or in mixtures of the isomers, 3,3′-dimethyl-4,4′-diaminodicyclohexylmethane, N-cyclohexyl-1,3-propanediamine, 1,2-diaminocyclohexane, 3-(cyclohexylamino)propylamine, TCD diamine (3(4),8(9)-bis(aminomethyl)tricyclo[5.2.1.0^{2,6}]decane), 4-methylcyclohexane-1,3-diamine, amines having a cyclic amino group and at least one acyclic primary or secondary amino group, preferably 1-(3-aminoethyl)piperazine (AEP), 1-(3-aminopropyl)piperazine;
araliphatic amines, preferably xylylenediamines;
aromatic amines, preferably phenylenediamines, especially phenylene-1,3-diamine and phenylene-1,4-diamine, and 4,4′-diaminodiphenylmethane, 2,4′-diaminodiphenylmethane, 2,2′-diaminodiphenylmethane, optionally alone or in mixtures of the isomers;
adduct hardeners, especially reaction products of epoxy compounds, especially glycidyl ethers of bisphenol A and F, with excess amine;
polyamidoamine hardeners, especially polyamidoamine hardeners obtained by condensation of mono- and polycarboxylic acids with polyamines, very especially by condensation of dimer fatty acids with polyalkylenepolyamines;
Mannich base hardeners, especially Mannich base hardeners obtained by reaction of mono- or polyhydric phenols with aldehydes, especially formaldehyde, and polyamines; and
Mannich bases, especially based on phenol and/or resorcinol, formaldehyde and m-xylylenediamine, and also N-aminoethylpiperazine and blends of N-aminoethylpiperazine with nonylphenol and/or benzyl alcohol, phenalkamines which are obtained in a Mannich reaction from cardanols, aldehydes and amines.

It is also possible to use mixtures of the aforementioned di- or polyamines as component d).

Preferred further auxiliaries and admixtures e) may be the compounds customary in epoxy chemistry. Preferred auxiliaries and admixtures e) are pigments, solvents, levelling agents, modifiers, degassing agents, flatting agents, reactive diluents, and catalysts, for example salicylic acid.

In a preferred embodiment, no amines d) are used. In a preferred embodiment, no further modifiers are present. In a preferred embodiment, no catalysts are used. Most preferably, the possible auxiliaries and admixtures are thus limited to pigments, solvents, levelling agents, degassing agents, flatting agents and reactive diluents.

The composition of components a) to e) in the composition according to the invention is preferably the following percentages by weight, based on the total mass of the composition:

a) epoxy resin 30-89%

b) cyclic amine 1-50%

c) alcohol 10-40%,

d) further amine 0-59% and

e) further auxiliaries or additives 0-59%.

Preferably, in addition, the percentages by weight of the amines b) based on the total mass of the amines b) and d) is at least 10% by weight, more preferably at least 30% by weight, even more preferably at least 50% by weight and more preferably still at least 70% by weight.

The invention further provides a process for producing a composition according to the invention, in which at least one epoxy resin a), at least one cyclic amine b) and at least one alcohol c) are mixed with one another.

The invention further provides for the use of the compositions according to the invention as casting resin, coating composition, composite or adhesive or as a constituent thereof.

### EXPERIMENTAL

### Example 1

100 parts homopiperazine (Aldrich) are intimately mixed with 66 parts benzyl alcohol and 380 parts Epikote 828 (epoxy equivalent 190, Hexion) and a DSC is taken immediately thereafter.

### Example 2

100 parts homopiperazine (Aldrich) are intimately mixed with 400 parts benzyl alcohol and with 380 parts Epikote 828 (epoxy equivalent 190, Hexion) and a DSC is taken immediately thereafter.

| | | |
|---|---|---|
| Recipe No. | 1 | 2 |

DSC analysis immediate

| | | | |
|---|---|---|---|
| Exothermic peak | ° C. | 70 | 61 |
| Onset | ° C. | 32 | 24 |
| Exothermic heat flow | J/g | 362 | 167 |
| Tg max. | ° C. | 58 | 63 |

In Example 2, the exothermic peak is lower, as is the onset of this exothermic peak. The composition according to Example 2 is thus more reactive than that according to Example 1.

1. A composition comprising
a) at least one epoxy resin,
b) at least one amine having at least two secondary amino groups that are both part of an organic ring system, and
c) at least one alkyl alcohol optionally substituted by at least one aromatic radical and/or by at least one alkenyl radical.

2. The composition according to claim 1,
wherein the at least one epoxy resin is a polyepoxide based on bisphenol A diglycidyl ether, bisphenol F diglycidyl ether, 4,4′-methylenebis[N,N-bis(2,3-epoxypropyl)aniline], hexanediol diglycidyl ether, butanediol diglycidyl ether, trimethylolpropane triglycidyl ether, propane-1,2,3-triol triglycidyl ether, pentaerythritol tetraglycidyl ether and diglycidyl hexahydrophthalate.

3. The composition according to claim 1, wherein all the secondary cyclic amino groups belong to the same cycle.

4. The composition according to claim 3,
wherein the amine has the formula (I) 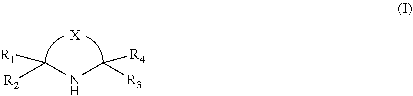
in which
R¹ to R⁴ is H or an organic radical, and
X=—(Y¹)ₘ-(A¹)ₙ-(Y²)ₒ-(A²)ₚ-(Y³)_{q}-(A³)ᵣ-(Y⁴)ₛ, (III)
where, independently of one another,
m, n, o, p, q, r and s=0 or 1
A¹, A², A³=alkylene or alkenylene radical and
Y¹, Y², Y³, Y⁴=NR⁵, PR⁵, O or S, with R⁵ independently=H or organic material,
where any two organic radicals selected from R¹ to R⁵ and any radicals present in the alkylene and/or alkenylene radicals A¹, A², A³ may also form one or more further rings,
wherein at least one of the radicals selected from Y¹, Y², Y³, Y⁴ present is NR⁵ with R⁵=H.

5. The composition according to claim 1, wherein the amine b) is selected from the group consisting of 3,7-diazabicyclo[4.3.0]nonane, 2,8-diazabicyclo[4.3.0]nonane, 2-phenyl-2-imidazoline, 3,8-diazabicyclo[3.2.1]octane, 2,2′-bisimidazolidine, 1H-octahydroimidazo[4,5-c]pyridine, 1,4,8-triazaspiro[4.5]decane, 1,4-diazaspiro[4.5]decane, pyrazolidine, 2,2-dimethylimidazolidine, 1,4,7-triazacyclononane, decahydro-2,6-dimethylpyrazino[2,3-b]pyrazine, hexahydropyridazine, decahydro-4a,8a-dimethylpyrazino[2,3-b]pyrazine, 4,4′-methylenebis[piperidine], 2,2′-methylenebis[piperidine], tetradecahydro-4,7-phenanthroline, 2,2′-bipiperidine, 4,4′-bipiperidine, tetradecahydrophenazine, decahydroquinoxaline, 1,5-decahydronaphthyridine, octahydro-1H-cyclopentapyrazine, 2,2′-bipyrrolidine, piperazine, 2-methylpiperazine, 2,2-dimethylpiperazine, 2,3-dimethylpiperazine, 2-ethylpiperazine, 2,5-dimethylpiperazine, 2,6-dimethylpiperazine, 2,6-diazabicyclo[3.3.0]octane, 3,7-diazabicyclo[3.3.0]octane, 2,3,5,6-tetramethylpiperazine, 2,3,5-trimethylpiperazine, 2,2′-bipiperidine, 2-(2-piperidinyl)piperazine, 2,2′-bimorpholine, decahydro-2,6-naphthyridine, decahydro-2,7-naphthyridine, homopiperazine, 2-methylhomopiperazine, 6-methyl-1,4-diazepane, bis[2-(piperazin-1-ypethyl]amine, 1,2-dipiperazinoethane, 1,3-bis(4-piperidyl)propane and N-(4-piperidinylmethyl)-4-piperidinemethanamine.

6. The composition according to claim 1, wherein the at least one alcohol has only one OH group.

7. The composition according to claim 6,
wherein the alcohol is selected from the group consisting of methanol, ethanol, propanol, butanol, benzyl alcohol, substituted benzyl alcohols and reaction products of benzyl alcohol with ethylene oxide or propylene oxide.

8. The composition according to claim 1, wherein the boiling point of the alcohol is at least 200° C. at 1013 mbar.

9. The composition according to claim 1, wherein the alcohol is benzyl alcohol.

10. The composition according to claim 1, wherein the contribution of the alcohol to the total concentration of OH groups is at least 1.3 mol/l.

11. The composition according to claim 1, wherein the composition also includes
d) amines that do not have at least two secondary amino groups as part of an organic ring system, and/or
e) further auxiliaries or additives.

12. The composition according to claim 11,
wherein the amines d) are selected from
aliphatic amines,
oxyalkylenepolyamines
cycloaliphatic amines,
amines having a cyclic amino group and at least one acyclic primary or secondary amino group,
araliphatic amines,
aromatic amines
adduct hardeners,
polyamidoamine hardeners
Mannich base hardeners and
Mannich bases.

13. The composition according to claim 1, wherein the composition includes components a) to e) in the following percentages by weight, based on the total mass of the composition:
a) epoxy resin from 30-89%
b) cyclic amine from 1-50%
c) alcohol from 10-40%
d) further amine from 0-59% and
e) further auxiliaries or additives from 0-59%.

14. The composition according to claim 11, wherein the percentage by weight of the amines b) based on the total mass of the amines b) and d) is at least 10% by weight.

15. The process for producing a composition according to claim 11, wherein at least one epoxy resin a), at least one cyclic amine b) and at least one alcohol c) are mixed with one another.

16. A product selected from the group consisting of casting resin, coating composition, composite, and adhesive, wherein the product comprises the composition according to claim 1.

17. The composition according to claim 2, wherein all the secondary cyclic amino groups belong to the same cycle.

18. The composition according to claim 17,
wherein the amine has the formula (I) 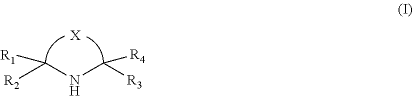
in which
R¹ to R⁴ is H or an orgnaic radical, and
X=—(Y¹)ₘ-(A¹)ₙ-(Y²)ₒ-(A²)ₚ-(Y³)_{q}-(A³)ᵣ-(Y⁴)ₛ, (II)
where, independently of one another,
m, n, o, p, q, r and s=0 or 1,
A¹, A², A³=alkylene or alkenylene radical and
Y¹, Y², Y³, Y⁴=NR⁵, PR⁵, O or S, with R⁵ independently=H or organic radical,
where any two organic radicals selected from R¹ to R⁵ and any radicals present in the alkylene and/or alkenylene radicals A¹, A², A³ may also form one or more further rings,
wherein at least one of the radicals selected from Y¹, Y², Y³, Y⁴ present is NR⁵ with R⁵=H.

19. The composition according to claim 2, wherein the amine b) is selected from the group consisting of 3,7-diazabicyclo[4.3.0]nonane, 2,8-diazabicyclo[4.3.0]nonane, 2-phenyl-2-imidazoline, 3,8-diazabicyclo[3.2.1]octane, 2,2′-bisimidazolidine, 1H-octahydroimidazo[4,5-c]pyridine, 1,4,8-triazaspiro[4.5]decane, 1,4-diazaspiro[4.5]decane, pyrazolidine, 2,2-dimethylimidazolidine, 1,4,7-triazacyclononane, decahydro-2,6-dimethylpyrazino[2,3-b]pyrazine, hexahydropyridazine, decahydro-4a,8a-dimethylpyrazino[2,3-b]pyrazine, 4,4′-methylenebis[piperidine], 2,2′-methylenebis[piperidine], tetradecahydro-4,7-phenanthroline, 2,2′-bipiperidine, 4,4′-bipiperidine, tetradecahydrophenazine, decahydroquinoxaline, 1,5-decahydronaphthyridine, octahydro-1H-cyclopentapyrazine, 2,2′-bipyrrolidine, piperazine, 2-methylpiperazine, 2,2-dimethylpiperazine, 2,3-dimethylpiperazine, 2-ethylpiperazine, 2,5-dimethylpiperazine, 2,6-dimethylpiperazine, 2,6-diazabicyclo[3.3.0]octane, 3,7-diazabicyclo[3.3.0]octane, 2,3,5,6-tetramethylpiperazine, 2,3,5-trimethylpiperazine, 2,2′-bipiperidine, 2-(2-piperidinyl)piperazine, 2,2′-bimorpholine, decahydro-2,6-naphthyridine, decahydro-2,7-naphthyridine, homopiperazine, 2-methylhomopiperazine, 6-methyl-1,4-diazepane, is[2-(piperazin-1-ypethyl]amine, 1,2-dipiperazinoethane, 1,3-bis(4-piperidyl)propane and N-(4-piperidinylmethyl)-4-piperidinemethanamine.

20. The composition according to claim 2, wherein the at least one alcohol has only one OH group.
